(19) United States
(12) Patent Application Publication
(10) Pub. No.: US 2008/0007112 A1
(43) Pub. Date: Jan. 10, 2008

(54) CONTROL SYSTEM AND METHOD FOR ELECTRIC-POWERED FORKLIFTS

(76) Inventor: Joon Ha Hwang, Seoul (KR)

Correspondence Address: BROUSE MCDOWELL LPA, 388 SOUTH MAIN STREET, SUITE 500, AKRON, OH, 44311, US

(21) Appl. No.: 11/845,246

(22) Filed: Aug. 27, 2007

(30) Foreign Application Priority Data
Dec. 23, 2005 (KR) 10-2005-128946

(51) Int. Cl. B60T 13/74

(52) U.S. Cl. 303/3

(57) ABSTRACT

Disclosed herein is a system and method for controlling an electric-powered forklift. The control system of the present invention includes a travel motor, an actuation unit motor, travel sensing means, actuation unit sensing means, and a controller. The travel motor drives a wheel, and an actuation unit motor drives an actuation unit. The travel sensing means senses whether the forklift is traveling. The actuation unit sensing means senses whether the actuation unit is operating. The controller controls the travel motor so that it is in a zero speed state if a signal is input from the actuation unit sensing means when no signal is input from the travel sensing means, thus restraining the motion of the forklift.

### I. BACKGROUND OF THE INVENTION

This application claims the benefit of the Korean Patent Application No. 10-2005-128946, filed on Dec. 23, 2005, which is hereby incorporated by reference as if fully set forth herein.

A. Field of Invention

The present invention relates, in general, to a control system and method for an electric-powered forklift, more particularly, to a control system and method for an electric-powered forklift, which can automatically brake the forklift without requiring a driver to perform a manual operation.

B. Description of the Related Art

An electric-powered forklift is a vehicle using the electricity of a battery as a power source. Such an electric-powered forklift includes a travel motor for enabling the vehicle to travel, and an actuation unit motor for driving an actuation unit, such as a lift cylinder or tilt cylinder.

Further, the electric-powered forklift includes a travel brake unit for braking the vehicle during traveling, and a parking brake unit for keeping the vehicle in a stationary state when parked.

The travel brake unit is a multi-plate brake that performs braking by pressing a disc installed on an axle shaft using a friction plate, and that operates when a driver steps on a brake pedal installed near a driver's seat, thus braking the vehicle during traveling.

The parking brake unit is a band-type parking brake that performs braking by pressurizing the circumferential portion of a drum, installed on an axle shaft, using a band, and that operates when a driver operates a parking lever or the like, installed near a driver's seat, thus keeping the vehicle in a stationary state when parked.

However, the conventional electric-powered forklift is disadvantageous in that, whenever traveling stops and an actuation unit is operated, the vehicle must be braked by manipulating the brake pedal or parking lever.

That is, in general, when traveling stops and goods are loaded or unloaded, the vehicle is braked by manipulating the travel brake unit or parking brake unit to stabilize the vehicle, and thereafter performs work. In particular, when loading or unloading goods in an inclined place, the vehicle may be pushed downwards. Accordingly, after the travel brake unit or the parking brake unit is manipulated to brake the vehicle, work is performed. Therefore, the conventional electric-powered forklift is very inconvenient in that the travel brake pedal or parking lever must be manually manipulated whenever traveling operation stops and work is performed.

### II. SUMMARY OF THE INVENTION

Accordingly, the present invention has been made keeping in mind the above problems occurring in the prior art, and an object of the present invention is to provide a control system and method for an electric-powered forklift, which can maximize the convenience and safety of a driver even when the vehicle is braked in order to perform work.

In order to accomplish the above object, the present invention provides a control system for an electric-powered forklift, the electric-powered forklift including a travel motor for driving a wheel, and an actuation unit motor for driving an actuation unit, comprising travel sensing means for sensing a traveling operation of a driver; an actuation unit sensing means for sensing an operation of the actuation unit; and a controller for controlling the travel motor in response to signals output from the travel sensing means and the actuation unit sensing means, respectively, wherein, if the actuation unit is operated when the traveling operation is not performed, the forklift is controlled by the controller so that the forklift is in a zero speed state, in which actual motion of the forklift is not allowed.

Further, the present invention provides a control method for an electric-powered forklift, the electric-powered forklift including a travel motor for driving a wheel, and an actuation unit motor for driving an actuation unit, comprising the steps of sensing input of a traveling signal corresponding to a traveling operation of a driver; sensing input of an actuation unit operation signal corresponding to driving of the actuation unit; and controlling the forklift so that it is in a zero speed state, in which the forklift actually stops, wherein the zero speed control step is performed when only the actuation unit operation signal is input, without the traveling signal being input.

### III. BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a first embodiment of a control system for an electric-powered forklift according to the present invention;

FIG. 2 is a flowchart showing a control method for an electric-powered forklift using the control system according to the first embodiment of the present invention;

FIG. 3 is a block diagram showing a second embodiment of a control system for an electric-powered forklift according to the present invention;

FIG. 4 is a flowchart showing a control method for an electric-powered forklift using the control system according to the second embodiment of the present invention;

FIG. 5 is a block diagram showing a third embodiment of a control system for an electric-powered forklift according to the present invention;

FIG. 6 is a flowchart showing a control method for an electric-powered forklift using the control system according to the third embodiment of the present invention;

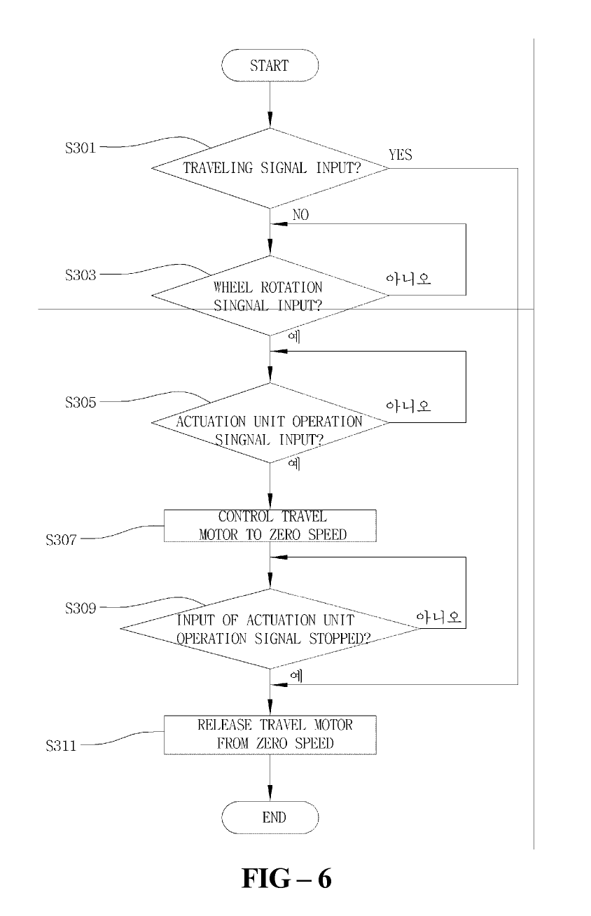

FIG. 7 is a block diagram showing a fourth embodiment of a control system for an electric-powered forklift according to the present invention; and

FIG. 8 is a flowchart showing a control method for an electric-powered forklift using the control system according to the fourth embodiment of the present invention.

### IV. DESCRIPTION OF PREFERRED EMBODIMENTS

Reference now should be made to the drawings, in which the same reference numerals are used throughout the different drawings to designate the same or similar components.

Hereinafter, embodiments of a control system and method for an electric-powered forklift according to the present invention will be described in detail with reference to the attached drawings.

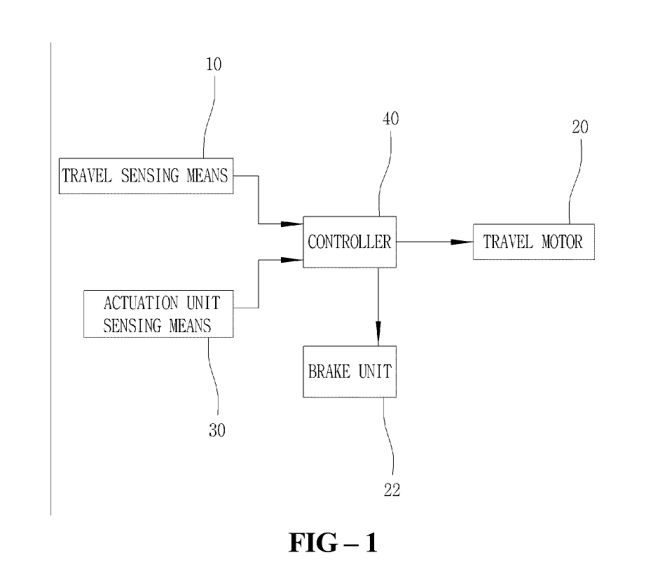

FIG. 1 illustrates a first embodiment of a control system for an electric-powered forklift according to the present invention.

The control system according to the first embodiment includes a travel sensing means 10 for sensing whether a vehicle is traveling.

The travel sensing means 10 is a sensor for sensing whether a driver is pressing an accelerator pedal (not shown), and can be implemented using a rotation sensor for sensing the slope of the accelerator pedal, or a pressure sensor for sensing the distance that the accelerator pedal is pressed.

Such a travel sensing means 10 senses that the vehicle is currently traveling by outputting a traveling signal when the driver steps on the accelerator pedal.

In another example, the travel sensing means 10 can be implemented using a current sensor for sensing the flow of current in a travel motor 20. The current sensor senses the flow of current in the travel motor 20, thus sensing whether the travel motor 20 is currently being driven and the vehicle is traveling.

In a further example, the travel sensing means 10 can be implemented using a forward/backward lever position sensor for sensing the position of a forward/backward lever. The forward/backward lever position sensor senses the position of the forward/backward lever, which is moved to a forward position or a backward position, thus sensing whether the vehicle is currently traveling.

Referring to FIG. 1 again, the control system of the present invention includes an actuation unit sensing means 30 for sensing whether an actuation unit is currently operating.

The actuation unit sensing means 30 is implemented using a rotation sensor for sensing the rotation of the shaft of an actuation unit motor (not shown), and is operated to sense the rotation of the actuation unit motor, thus sensing whether the vehicle is currently performing work. Preferably, the rotation sensor is implemented using a rotary encoder installed on the shaft of the actuation unit motor.

In another example, the actuation unit sensing means 30 can be implemented using a hydraulic oil sensor for sensing the flow of hydraulic oil flowing into an actuation unit. The hydraulic oil sensor senses the flow of hydraulic oil, flowing into the actuation unit, thus sensing whether an actuation unit is currently operating, and consequently sensing whether the vehicle is currently performing work.

Referring to FIG. 1 again, the control system of the present invention includes a controller 40 for controlling the travel motor 20 in response to signals output from the travel sensing means 10 and the actuation unit sensing means 30.

The controller 40 is provided with a microprocessor, and is operated to determine that the vehicle has currently stopped traveling and is only performing work if a signal is input from the actuation unit sensing means 30 when no signal is input from the travel sensing means 10, thus controlling the vehicle so that the vehicle is actually in a stopped state, that is, a “zero speed” state. Such a “zero speed” state can be realized by controlling the travel motor 20, or by driving a brake unit 22. The brake unit in this embodiment is operated by oil pressure, and such a zero speed state is maintained by causing oil pressure to be automatically applied to the brake unit 22 by the controller 40.

The “zero speed” state is released when a traveling signal is input from the travel sensing means 10 or when the input of a sensed signal from the actuation unit sensing means 30 is stopped. If a signal is input from the actuation unit sensing means 30 again after the “zero speed” state is released in this way, the vehicle is controlled again so that it is in the “zero speed” state. Of course, even in this case, the state in which no traveling signal is input from the travel sensing means 10 must be realized.

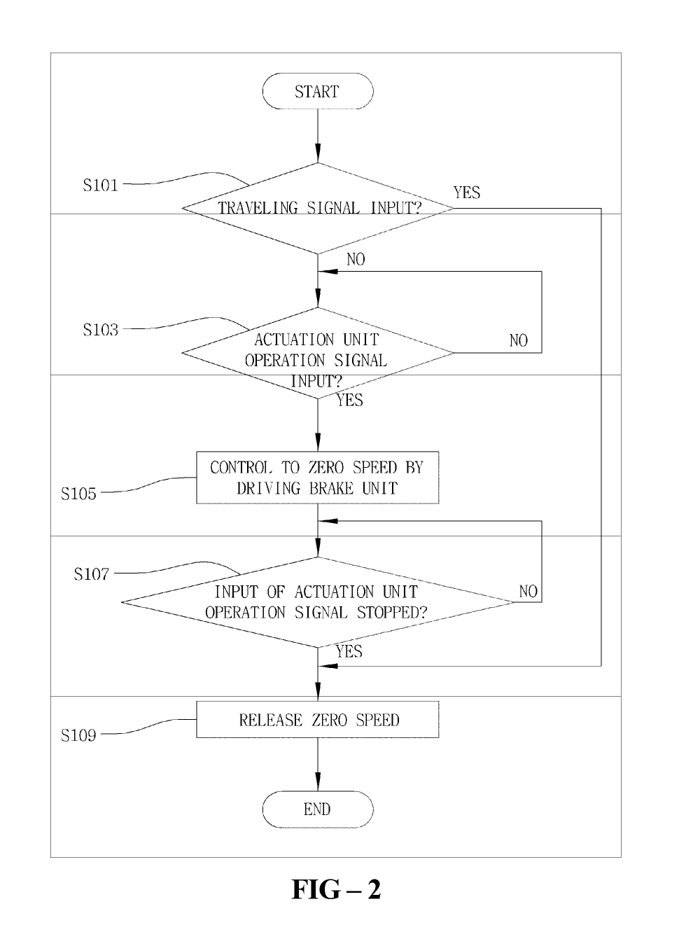

Next, a control method for an electric-powered forklift using the control system according to the first embodiment of the present invention is described in detail with reference to FIGS. 1 and 2.

First, whether a traveling signal is input from the travel sensing means 10 is sensed at step S101. As a result of the sensing, if no traveling signal is found to be input, whether an actuation unit operation signal is input from the actuation unit sensing means 30 is sensed at step S103.

As a result of the sensing, if the actuation unit operation signal is found to be input, the controller 40 determines that the vehicle has currently stopped traveling and is only performing world thus driving the brake unit 22, and consequently controlling the vehicle so that it is in a “zero-speed” state at step S105. Therefore, the vehicle can stably perform the operation of unloading or loading goods.

Meanwhile, when a traveling signal is input from the travel sensing means 10 at step S101, or when the input of an actuation unit operation signal from the actuation unit sensing means 30 is stopped at step S107 while the vehicle is in the “zero speed” state, the controller 40 releases the brake unit so that the vehicle is released from the zero speed state at step S109.

In the control method according to the first embodiment of the present invention, since the vehicle is automatically stopped and is maintained in the “zero speed” state while performing work, the position of the vehicle can be automatically and stably maintained. Therefore, the present invention can minimize the driver's convenience, unlike the prior art, which forces the driver to manually brake the vehicle.

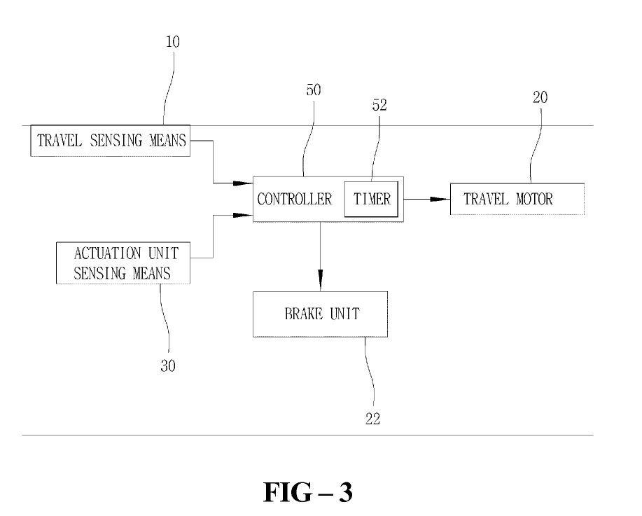

Next, FIG. 3 illustrates a second embodiment of a control system for an electric-powered forklift according to a second embodiment of the present invention.

The control system according to the second embodiment includes a controller 50 for processing signals output from a travel sensing means 10 and an actuation unit sensing means 30, the controller 50 including a timer 52.

The timer 52 counts the time for which the input of a sensed signal is stopped when the input of the sensed signal from the actuation unit sensing means 30 is stopped.

Further, when the time counted by the timer 52, that is, the time for which the input of the sensed signal is stopped, exceeds a preset time, the controller 50 determines that the actuation unit is not currently being used, thus releasing the vehicle from the “zero speed” state. The preset time stored in the controller 50 is preferably about five minutes.

Such a controller 50 according to the second embodiment of the present invention differs from that of the first embodiment only in the above-described way, and the construction and operation thereof is otherwise identical to the first embodiment. Therefore, a detailed description thereof is omitted.

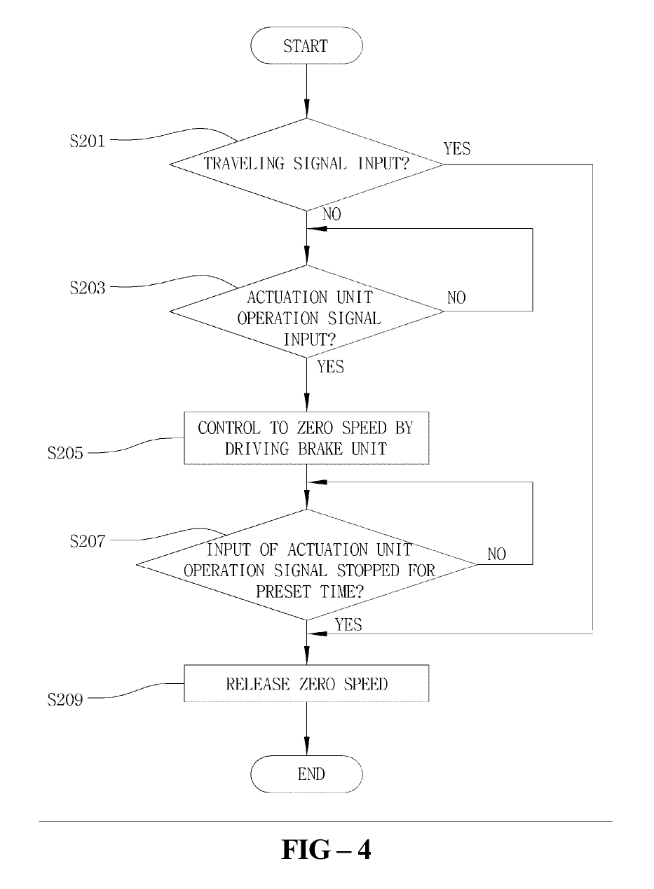

Next, a control method for an electric-powered forklift using the control system according to the second embodiment of the present invention is described with reference to FIGS. 3 and 4.

First, whether a traveling signal is input from the travel sensing means 10 is sensed at step S201. In this case, if no traveling signal is found to be input, whether an actuation unit operation signal is input from the actuation unit sensing means 30 is sensed at step S203.

If an actuation unit operation signal is found to be input as a result of the sensing, the controller 50 determines that the vehicle has currently stopped traveling and is only performing work, thus driving the brake unit 22, and consequently controlling the vehicle so that it is in a “zero speed” state at step S205. Accordingly, the vehicle can stably perform the operation of unloading or loading goods.

Meanwhile, when a traveling signal is input from the travel sensing means 10 at step S201 or when the input of an actuation unit operation signal from the actuation unit sensing means 30 is stopped at step S207 while the vehicle is in the “zero speed” state, the controller 50 releases the brake unit 22, thus immediately releasing the vehicle from the zero speed state at step S209.

Meanwhile, after the travel motor 20 is released from the “zero speed” state, if the actuation unit operation signal is input again from the actuation unit sensing means 30 at step S203, the vehicle is controlled again so that it is in the “zero speed” state at step S205. Of course, even in this case, the state in which no traveling signal is input from the travel sensing means 10 must be realized.

Accordingly, the control method according to the second embodiment of the present invention uses a scheme for releasing the “zero speed” state after a preset time has elapsed even if the input of the actuation unit operation signal from the actuation unit sensing means 30 is stopped, thus preventing the braked state of the vehicle from being released even when the driver of the vehicle temporarily stops the operation of the actuation unit.

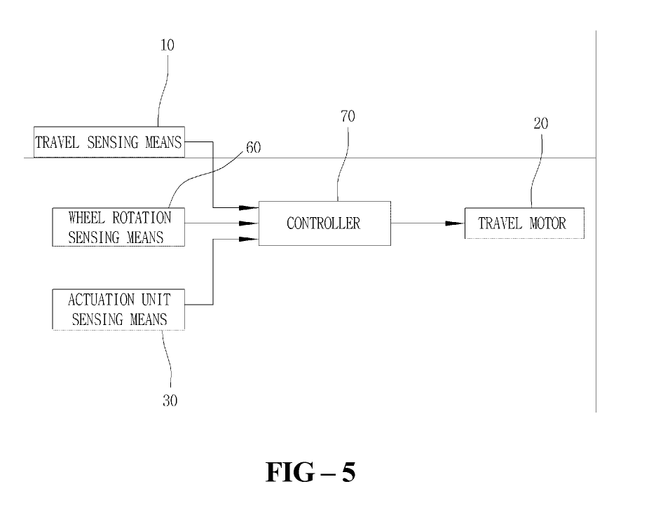

Next, FIG. 5 illustrates a third embodiment of a control system for an electric-powered forklift according to the present invention.

The control system according to the third embodiment further includes a wheel rotation sensing means 60 for sensing whether the wheel of the vehicle is rotating.

The wheel rotation sensing means 60 is implemented using a rotation sensor for sensing the rotation of an axle shaft (not shown) connected to the wheel of the vehicle. In another example, the wheel rotation sensing means 60 can be implemented using a rotation sensor for sensing the rotation of the shaft of the travel motor 20 connected to the wheel.

Such a wheel rotation sensing means 60 senses the rotation of the axle shaft or the travel motor 20, thus sensing whether the vehicle is currently rotating. In particular, the wheel rotation sensing means 60 senses whether the wheel is performing idle rotation regardless of the driving force of the travel motor 20. Preferably, a rotary encoder is used as the rotation sensor.

Further, the control system according to the third embodiment of the present invention includes a controller 70 for controlling the travel motor 20 in response to signals output from the travel sensing means 10, the actuation unit sensing means 30 and the wheel rotation sensing means 60.

If signals are simultaneously input from the actuation unit sensing means 30 and the wheel rotation sensing means 60 while no signal is input from the travel sensing means 10, the controller determines that the vehicle is not currently traveling and is performing work while being pushed downwards in an inclined place, thus controlling the travel motor 20.

The travel motor 20 is controlled so that the “zero speed” state thereof is maintained by the application of predetermined reverse current. That is, when the vehicle is moved by a load while no signal is input from the travel sensing means 10, the reverse current is applied so that reversal rotary power is generated at the travel motor 20 in a reverse direction relative to the direction in which the vehicle is moved. Here, the reversal rotary power can have any intensity enabling the vehicle to be maintained in the “zero speed” state. However, if the wheel is intended to rotate in a reverse direction due to the excessively high intensity of reverse current, an operation of lifting goods, etc., reverse current is applied in a reverse direction relative to that direction, thus maintaining the vehicle in the “zero speed” state. The application of such reverse current is alternately performed, thus the vehicle can be maintained in a stopped state in actuality.

Meanwhile, as described above, when the travel motor 20 can be controlled, the control system can be constructed so that the brake is automatically driven if the driver does not conduct a traveling operation even during the traveling of the vehicle. That is, even during traveling, the control system can increase the convenience of the driver of the vehicle. In this case, it is preferable that, if the condition of “zero speed” is satisfied after the vehicle stops traveling, control for “zero speed” be successively started. When the vehicle is fully stopped by the automatic brake function in this way, the stopped state of the vehicle cannot be maintained if the actuation unit is not operated immediately after the vehicle has stopped. In particular, when the vehicle is parked in an inclined place, there is a probability that the vehicle will move due to the load thereof, thus causing an accident. Such a problem can be prevented by controlling the travel motor 20 to remain in the same state as the above-described “zero speed” state even if the actuation unit is not driven for a certain period of time after the vehicle has stopped. Such an advantage can be easily achieved when the timer, described in the above embodiment, can be used together with the function.

Meanwhile, if a traveling signal is input from the travel sensing means 10 while the travel motor 20 is in the “zero speed” state, the controller 70 drives the travel motor 20 normally.

Further, if the input of the sensed signal from the actuation unit sensing means 30 is stopped after the travel motor 20 has been controlled to be in the “zero speed” state, the controller 70 determines that the actuation unit is not currently being used, and thus immediately releases the travel motor 20 from the “zero speed” state.

Further, if a signal is input again from the actuation unit sensing means 30 after the travel motor 20 has been released from the “zero speed” state, the controller 70 maintains the travel motor 20 in the “zero speed” state again. Of course, even in this case, a state in which no traveling signal is input from the travel sensing means 10 must be realized.

Next, a control method for an electric-powered forklift using the control system according to the third embodiment of the present invention is described in detail.

First, whether a traveling signal is input from the travel sensing means 10 is sensed at step S301. In this case, if no traveling signal is found to be input, whether a wheel rotation signal is input from the wheel rotation sensing means 60 is sensed at step S303. If the wheel rotation signal is found to be input as a result of the sensing, whether an actuation unit operation signal is input from the actuation unit sensing means 30 is sensed at step S305.

If an actuation unit operation signal is found to be input as a result of the sensing, the controller 70 determines that the vehicle currently stops traveling and is performing work while being pushed downwards in an inclined place, and thus controls the travel motor 20 so that it is in a “zero speed” state at step S307.

In this state, since the travel motor 20 is maintained in the zero speed state, forward/backward rotation of the travel motor is prevented. Accordingly, since the forward/backward rotation of the travel motor 20 can be prevented, the vehicle is maintained in its braked state while the motion thereof is restrained. Therefore, the vehicle can be stably maintained without being pushed downwards even in an inclined place, thus performing the operation of unloading or loading goods.

Meanwhile, if a traveling signal is found to be input from the travel sensing means 10 after the travel motor 20 has been controlled to remain in the “zero speed” state at step S301, the controller 70 immediately releases the travel motor 20 from the zero speed state at step S311.

Further, the controller 70 senses whether the input of the actuation unit operation signal from the actuation unit sensing means 30 is stopped after the travel motor 20 has been controlled to be in the “zero speed” state at step S309.

If the input of the actuation unit operation signal is found to be stopped as a result of the sensing, the controller 70 determines that the actuation unit is not currently being used, thus immediately releasing the travel motor 20 from the “zero speed” state at step S311.

In this case, since the travel motor 20 is released from the “zero speed” state, the travel motor 20 can be freely rotated forward or backward, and thus travel forward or backward.

Meanwhile, if an actuation unit operation signal and a wheel rotation signal are input again from the actuation unit sensing means 30 and the wheel rotation sensing means 60, respectively, after the travel motor 20 has been released from the “zero speed” state, at steps S303 and S305, the travel motor 20 is controlled again so that it is in the “zero speed” state at step S307. Of course, even in this case, the state in which no traveling signal is input from the travel sensing means 10 must be realized.

In the control method according to the third embodiment of the present invention, if the vehicle is performing work in an inclined place, the travel motor 20 is automatically maintained at the “zero speed” state to stop the vehicle, so that the vehicle can perform work while maintaining a stable state even in an inclined place.

Further, since the vehicle automatically stops without requiring a driver to perform a manual operation, the inconvenience of forcing the driver to manipulate a travel brake unit or parking brake unit when performing work in an inclined place can be eliminated, thus being very convenient for the driver.

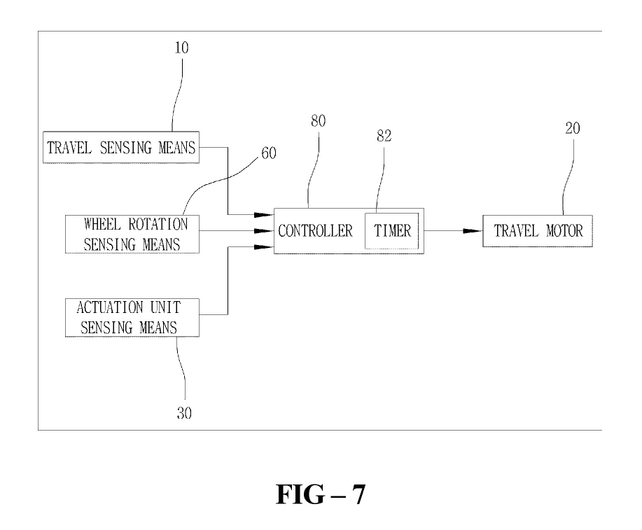

Next, FIG. 7 illustrates a fourth embodiment of a control system for an electric-powered forklift according to the present invention.

The control system according to the fourth embodiment includes a controller 80 for processing signals input from a travel sensing means 10, an actuation unit sensing means 30, and a wheel rotation sensing means 60, the controller 80 including a timer 82.

The timer 82 counts the time for which the input of a sensed signal from the actuation unit sensing means 30 is stopped when the input of the sensed signal is stopped.

Further, when the time counted by the timer 52, that is, the time for which the input of the sensed signal is stopped, exceeds a preset time, the controller 50 determines that the actuation unit is not being currently used, thus releasing the travel motor 20 from the “zero speed” state. The preset time stored in the controller 50 is preferably about five minutes.

Such a controller 80 according to the fourth embodiment differs from that of the third embodiment only in the above-described way, and the construction and operation thereof is otherwise identical to that of the third embodiment. Therefore, a detailed description thereof is omitted.

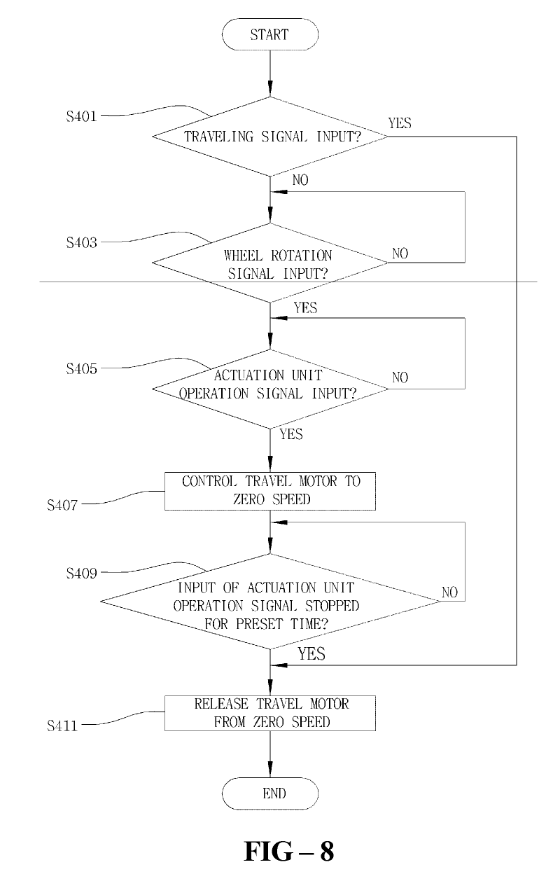

Next, a control method for an electric-powered forklift using the control system according to the fourth embodiment of the present invention is described with reference to FIGS. 7 and 8.

First, whether a traveling signal is input from the travel sensing means 10 is sensed at step S401. In this case, if no traveling signal is found to be input, whether a wheel rotation signal is input from the wheel rotation sensing means 60 is sensed at step S403. If a wheel rotation signal is found to be input as a result of the sensing, whether an actuation unit operation signal is input from the actuation unit sensing means 30 is sensed at step S405.

If an actuation unit operation signal is found to be input as a result of the sensing, the controller 80 determines that the vehicle currently stops traveling and is performing work while being pushed downwards in an inclined place, thus controlling the travel motor 20 so that it is in a “zero speed” state at step S407.

In this state, since the travel motor 20 is maintained in the zero speed state, the forward/backward rotation of the travel motor 20 is prevented. Accordingly, since the forward/backward rotation of the travel motor 20 is prevented, the motion of the vehicle is limited, and the braked state of the vehicle is maintained. Therefore, the vehicle is stably maintained without being pushed downwards even in an inclined place, thus the vehicle can stably perform the operation of unloading or loading goods.

Meanwhile, if a traveling signal is input from the travel sensing means 10 after the travel motor 20 has been controlled to be in the “zero speed” state at step S401, the controller 80 immediately releases the travel motor 20 from the zero speed state at step S411.

Further, the controller 80 senses whether the input of the actuation unit operation signal from the actuation unit sensing means 30 is stopped after the travel motor 20 has been controlled to be in the “zero speed” state while sensing whether the input of the actuation unit operation signal has been stopped for a preset time at step S409.

If the input of the actuation unit operation signal is found to have been stopped for the preset time as a result of the sensing, the controller 80 determines that the actuation unit is not currently being used, and thus releases the travel motor 20 from the “zero speed” state at step S411.

In this case, since the travel motor 20 is released from the “zero speed” state, the travel motor 20 can be freely rotated forward or backward, and thus travel forward or backward.

Meanwhile, if an actuation unit operation signal and a wheel rotation signal are input from the actuation unit sensing means 30 and the wheel rotation sensing means 60, respectively, after the travel motor 20 is released from the zero speed state, at steps S403 and S405, the travel motor 20 is controlled again so that it is in the “zero speed” state at step S407. Of course, even in this case, a state in which no traveling signal is input from the travel sensing means 10 must be realized.

The control method according to the fourth embodiment of the present invention employs a structure in which, even if the input of the actuation unit operation signal from the actuation unit sensing means 30 is stopped, the travel motor 20 is released from the “zero speed” state after the preset time has elapsed, thus preventing the vehicle from being released from a braked state even when the driver of the vehicle temporarily stops the operation of the actuation unit.

As described above, the control system and method for an electric-powered forklift according to the present invention is advantageous in that, since a travel motor is automatically maintained in a zero speed state when the vehicle stops traveling to perform work, the vehicle can be automatically braked without requiring a driver to perform a manual operation, thus maximizing the driver's convenience.

Further, the present invention is advantageous in that, when the vehicle is performing work in an inclined place, a travel motor is automatically maintained in a zero speed state to stop the vehicle, so that the vehicle can work while maintaining a stable state even in an inclined place.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A control system for an electric-powered forklift, the electric-powered forklift including a travel motor for driving a wheel, and an actuation unit motor for driving an actuation unit comprising:
travel sensing means for sensing a traveling operation of a driver;
an actuation unit sensing means for sensing an operation of the actuation unit; and
a controller for controlling the travel motor in response to signals output from the travel sensing means and the actuation unit sensing means, respectively,
wherein, if the actuation unit is operated when the traveling operation is not performed, the forklift is controlled by the controller so that the forklift is in a zero speed state, in which actual traveling of the forklift is not allowed.

2. The control system according to claim 1, further comprising wheel rotation sensing means for sensing rotation of the wheel, wherein the controller is operated so that, if rotation of the wheel is sensed when the traveling operation is not performed, the controller applies reverse current to the travel motor for generating a reverse rotary power corresponding to rotary power of the wheel, thus enabling the forklift to be in the zero speed state, and wherein the reverse rotary power is generated in a reverse direction relative to a rotating direction of the wheel.

3. The control system according to claim 2, wherein the controller controls the travel motor, if the forklift completes traveling and stops, to be in the zero speed state for a preset time starting immediately after the traveling has been completed, even if driving of the actuation unit is not detected.

4. The control system according to claim 2, wherein the controller comprises a timer for counting a time starting from a time point at which the driving of the actuation unit is stopped if the driving of the actuation unit is stopped in the zero speed state, the controller releasing the travel motor from the zero speed state if the time counted by the timer exceeds a preset time.

5. The control system according to claim 1, wherein the travel sensing means comprises a pressure sensor for sensing that an accelerator pedal is pressed.

6. The control system according to claim 1, wherein the wheel rotation sensing means comprises a rotation sensor for sensing rotation of an axle shaft connected to the wheel.

7. The control system according to claim 1, wherein the actuation unit sensing means comprises a rotation sensor for sensing rotation of a shaft of the actuation unit motor.

8. A control method for an electric-powered forklift, the electric-powered forklift including a travel motor for driving a wheel, and an actuation unit motor for driving an actuation unit, comprising the steps of:
sensing input of a traveling signal corresponding to a traveling operation of a driver;
sensing input of an actuation unit operation signal corresponding to driving of the actuation unit; and
controlling the forklift so that it is in a zero speed state, in which traveling of the forklift substantially stops,
wherein the zero speed control step is performed when only the actuation unit operation signal is input, without the traveling signal being input.

9. The control method according to claim 8, wherein the zero speed control step comprises the steps of:
sensing input of a wheel rotation signal corresponding to rotation of the wheel; and
applying reverse current to the travel motor for generating reversal rotary power corresponding to rotary power of the wheel,
wherein the reversal rotary power is generated in a reverse direction relative to a rotating direction of the wheel when the wheel rotation signal is input.

10. The control method according to claim 8, further comprising the step of detecting completion of traveling of the forklift when the forklift stops,
wherein the zero speed control step is performed for a preset time starting immediately after the traveling of the forklift is completed, even if the actuation unit operation signal is not input.

11. The control method according to claim 8, wherein:
if the zero speed control step is performed by input of the actuation unit operation signal when traveling signal is not input, the zero speed control step is terminated in response to either one of new input of the traveling signal or stoppage of input of the actuation unit operation signal, and
if input of the actuation unit operation signal is stopped, the zero speed control step is terminated after a preset tine has elapsed from a time point at which the driving of the actuation unit is stopped.
